(19) United States
(12) Patent Application Publication
(10) Pub. No.: US 2025/0308719 A1
(43) Pub. Date: Oct. 2, 2025

(54) TRANSPORTABLE NUCLEAR POWER PLANT

(71) Applicant: Energie propre Prodigy Ltee / Prodigy Clean Energy Ltd., Montreal (CA)

(72) Inventors: Mathias TROJER, Brookline, MA (US); Marcel DEVOS, Oxford Station (CA)

(21) Appl. No.: 18/866,305

(22) PCT Filed: May 19, 2023
(86) PCT No.: PCT/US2023/022903

§ 371 Date: Nov. 15, 2024

Related U.S. Application Data
(60) Provisional application No. 63/344,324, filed on May 20, 2022.

(51) Int. Cl. G21D 1/02; B63B 35/44; E04H 9/04

(52) U.S. Cl. CPC G21D 1/02; B63B 35/44; E04H 9/04; B63B 2035/4446

(57) ABSTRACT

A method for installing a transportable nuclear power plant at a site includes depositing the transportable nuclear power plant on a marine vehicle. The transportable nuclear power plant includes at least one adjustable support. The method also includes transporting the transportable nuclear power plant, via the marine vehicle, to a quay, where the quay provides access to an installation site on land. Still further, the method includes transitioning the transportable nuclear power plant from the marine vehicle to at least one land vehicle, transporting the transportable nuclear power plant to the installation site via the at least one land vehicle, and deploying the at least one adjustable support from the transportable nuclear power plant at the installation site.

### CROSS-REFERENCE TO RELATED APPLICATION(S)

This Patent Cooperation Treaty (“PCT”) patent application relies on and claim priority to U.S. Patent Application Ser. No. 63/344,324, filed on May 20, 2022, the entire content of which is incorporated herein by reference.

### FIELD OF THE INVENTION

The present invention relates to transport and deployment of prefabricated small modular reactor (SMR) power plants.

### DESCRIPTION OF THE RELATED ART

The global need for energy sources that are sustainable, low-cost, produce low carbon emissions, and have high energy density and high capacity factor is growing rapidly. Various novel nuclear power plant designs, including some that incorporate small modular reactors (SMRs), can meet this need while overcoming the drawbacks of earlier nuclear plants. It is desirable that novel plant designs minimize development footprint (e.g., near coastal population centers).

Moreover, to be secure and sustainable, novel designs are contemplated to be robust against potential impacts of climate change, including sea level rise and dwindling supplies of freshwater for cooling.

The designs also are contemplated to be robust against mechanical failures, malicious attack, human error, and natural disasters, including seismic events and tsunamis.

It is desirable that nuclear power plant designs avoid the high costs and decadal construction times that have persistently plagued large, one-off nuclear plants: site-specific design, approval, and construction processes entail high construction costs and long project durations that make conventional nuclear power projects expensive to finance and insure.

Coastal deployments of prefabricated nuclear power plants are able to address the foregoing needs. Such deployments also may minimize the deployment footprint and the emergency planning zones associated therewith, have access to inexhaustible coolant water, i.e., the sea, and benefit from marine delivery of large components that must otherwise be built on-site.

Various nuclear-plant proposals available in the prior art realize only some of these advantages, if only in part. Thus, a need exists for methods and systems that, without limitation to the scope of the embodiment(s) described herein, standardize design and construction of nuclear plants for coastal deployments; exploit the potential of marine transport for rapid, flexible delivery of large systems; minimize site-specific bespoke engineering costs; and realize other advantages of coastal deployments.

### SUMMARY OF THE INVENTION

Provided herein are methods, systems, components, and the like that enable centralized manufacturing, transporting, deploying, redeploying, fueling, and commissioning of a relocatable nuclear power plant structure, herein termed a Transportable Nuclear Power Plant (TNPP).

In one or more embodiments, the TNPP is a portable building or structure having one or more small modular reactors (SMRs), power-conversion, and other arrangements necessary to make the TNPP, in essence, a standalone producer of electrical and/or thermal energy that is designed to be geographically relocated and maneuvered on land over relatively short distances on prepared surfaces.

A TNPP, in various embodiments, preferably contains all elements of an SMR-based nuclear island and some or all additional elements of a nuclear power station (e.g., turbines, generators, control room, balance of plant systems, auxiliary systems, fuel-handling systems, etc.). The TNPP is agnostic toward the specific design of the SMRs within: that is, it can accommodate any of a number of SMR or reactor designs and nuclear island layouts, present and future.

Although the term “SMR” is employed herein, there is no restriction to any particular reactor design or type, fission or fusion, or other variations found in present or future nuclear heat generators. Preferably, standardized steam, electrical, and control interfaces connect a nuclear enclosure within the TNPP to the other systems of the TNPP. The nuclear enclosure is thus a “black box” within the TNPP that produces steam which is converted to electrical power by standard systems, and which may also provide heat for direct applications (e.g., heating, industrial process heat, etc.).

While not limiting of the present invention, the TNPP is preferably fabricated in a shipyard and transported overwater, without reactors and nuclear fuel, to a dedicated terrestrial site comprised by a coastal facility. The site may provide for protection of the TNPP from aircraft impacts, seismic events, and other challenges. The balance of the coastal facility typically includes one or more switchyards, administrative buildings, connections to a standard grid or microgrid, energy storage devices, and other components pertaining to energy transformation, storage, and distribution.

In some embodiments, power conversion may occur in the balance of the coastal facility rather than in the Marine Power Station (MPS). Reactors and fuel are preferably installed in the TNPP after the TNPP is installed at the designated deployment location.

The TNPP preferably comprises provisions for exchanging reactors and fresh and spent nuclear fuel, and/or a combination of both, between one or more land- or sea-based delivery systems and the interior of the nuclear enclosure.

The TNPP is preferably a complete facility intended to operate on a terrestrial surface, subsurface or marine environment, integrating the safety, security, and operational measures necessary to support the nuclear reactor and power conversion systems.

The TNPP is specifically designed to be geographically relocated, in a secure and controlled manner, either as a whole entity, or by using discrete transport modules.

Herein, a TNPP should be interpreted to encompass, but not be limited to, a complete facility (land- or marine-based) integrating one or more nuclear reactors and power conversion system(s) and specifically designed to be geographically relocated either as a whole entity or by using discrete transport modules. TNPPs may offer periodic on-site refueling, or use a permanently fueled and sealed reactor, depending on the reactor technology and how long the facility is intended to be in operation.

Various TNPPs can be designed to produce power over a wide range of outputs, as for example from a single megawatt to gigawatts, and can be used to deploy nuclear energy in locations where a traditionally constructed, fixed, land-based nuclear power plant is not technically or economically practical.

For the purposes of the instant discussion, a TNPP also comprises the use of nuclear energy onboard stationary-deployed and self-moving maritime vessels, including for the purposes of vessel propulsion.

Various embodiments of the invention realize a number of advantages over the prior art for creating nuclear power stations. These include shipyard fabrication of the TNPP, which enables faster construction and lower capital expenditure than one-off, on-site, terrestrial construction; turnkey delivery of one or more TNPPs to a coastal facility; flexible overwater transport from the TNPP site of manufacture to the coastal facility; redeployability of the TNPP (e.g., to another coastal facility), with attendant flexibility of business construct (e.g., short- or long-term leasing); portability of TNPP at end-of-lifetime to a scrapyard for cost-effective decommissioning; ability to locate the TNPP anywhere in the world that is accessible by suitable transport vessels, regardless of availability of terrestrial infrastructure (e.g., roads); and access to an effectively unlimited supply of cooling water, in contrast to conventional terrestrial nuclear plants that may be forced to cease operation when drought reduces cooling water supplies.

It is contemplated that the prepared site of a TNPP is, in various embodiments, relatively simple (compared, e.g., to an artificial harbor), comprising primarily a quay or modified shoreline accessible to a suitable transport vessel for offloading of the TNPP, a prepared way or track along which the TNPP may be moved, a site where the TNPP may stand for its operational lifetime at that particular coastal location, and an electrical connection to a local grid or energy consumer. Site modifications, some of which are discussed with reference to the Figures herein, can render the TNPP in various embodiments less vulnerable to aerial attack and to unauthorized removal of the whole facility or of one or more SMRs therefrom.

One contemplated embodiment of the present invention encompasses, but is not limited to, a method for installing a transportable nuclear power plant at a site. The method includes depositing the transportable nuclear power plant on a marine vehicle, where the transportable nuclear power plant comprises at least one adjustable support. Still further, the method includes transporting the transportable nuclear power plant, via the marine vehicle, to a quay, where the quay provides access to an installation site on land. Then, the transportable nuclear power plant is transitioned from the marine vehicle to at least one land vehicle, and the transportable nuclear power plant to the installation site via the at least one land vehicle. The at least one adjustable support is then deployed from the transportable nuclear power plant at the installation site.

In one variant, it is contemplated that the at least one adjustable support will encompass three adjustable supports. Still more adjustable supports may be employed, as required or desired.

In another contemplated embodiment, the method includes digging a swale around the installation site, thereby positioning the transportable nuclear power plant at least partially below a grade level. The swale reduces an angle of attack of the installation site from airborne threats.

The method also may include building a berm around the installation site, where the berm extends above a grade level. The berm reduces an angle of attack of the installation site from airborne threats.

In another example, the method includes digging a vault beneath the transportable nuclear power plant, wherein the vault is below a grade level and lowering a small modular reactor from the transportable nuclear power plant into the vault. The vault reduces an angle of attack of the installation site from airborne threats.

Other variations include combining one or more of the berm, swale, and vault together. For example, one method includes building a berm and a swale. Another example includes building a berm and digging a vault. Other variations also are contemplated to fall within the scope of the present invention. The berm, swale, and vault are contemplated to increase the angle of attack from an airborne threat, thereby providing increasing levels of security for the transportable nuclear power plant.

In another contemplated example, the method includes building at least one arch atop the berm between opposing sides thereof, where the at least one arch extends above the transportable nuclear power plant.

The present invention also encompasses, but is not limited to, a transportable nuclear power plant. The transportable nuclear power plant includes a civil structure adapted to contain at least one nuclear reactor therein and at least three adjustable supports disposed beneath the civil structure. The at least three adjustable supports are deployable from the civil structure to level the civil structure at an installation location for the transportable nuclear power plant.

In another example, the present invention encompasses a system for delivering a transportable nuclear power plant to an installation site. The system includes a civil structure adapted to contain a nuclear reactor, wherein the civil structure is transportable from a first location to the installation site, a marine vessel adapted to receive and transport the civil structure across a body of water, and at least one land vehicle adapted to receive the civil structure from the marine vessel and to transport the civil structure to the installation location.

The system may be varied such that the at least one land vehicle is a self-propelled modular transporter.

The system may be adapted so that the civil structure includes at least one adjustable support deployable from beneath the civil structure to level the civil structure at the installation location.

Alternatively, the system may be constructed so that the at least one adjustable support encompasses at least three adjustable supports.

Next, the system may be configured so that the installation location comprises a swale around the installation site, thereby positioning the transportable nuclear power plant at least partially below a grade level. Here, the swale is contemplated to reduce an angle of attack of the installation site from airborne threats.

The system of the present invention may be configured so that the installation location comprises a berm around the installation site, where the berm extends above a grade level and reduces an angle of attack of the installation site from airborne threats.

The system of the present invention also may be designed so that the installation location comprises a vault beneath the transportable nuclear power plant into which a small modular reactor may be lowered from the transportable nuclear power plant. The vault is contemplated to be below a grade level. The vault reduces an angle of attack of the installation site from airborne threats.

The system of the present invention may combine one or more of the berm, the swale, and the vault, as required or as desired. The berm, swale, and vault are contemplated to increase the angle of attack from an airborne threat, thereby providing increasing levels of security for the transportable nuclear power plant.

These and other distinguishing aspects of embodiments of the invention, along with various advantages of embodiments, will be clarified hereinbelow with reference to the Figures.

### BRIEF DESCRIPTION OF THE DRAWINGS

In the drawings, like reference characters generally refer to the same parts throughout the different views. Also, the drawings are not drawn to scale, emphasis instead generally being placed upon illustrating the principles of the invention. In the following description, various embodiments of the present invention are described with reference to the following drawings, in which:

FIG. 1A depicts a transportable nuclear power plant (TNPP) containing a small modular reactor (SMR).

FIG. 1B is a transverse cross-sectional view of the TNPP of FIG. 1A taken along line IB-IB.

FIG. 2 depicts an adjustable TNPP support with seismic isolation.

FIG. 3 depicts a TNPP being transported by a vessel.

FIG. 4A depicts a side view and at op view of a coastal prepared site before delivery of a TNPP.

FIG. 4B depicts a side view and at top view of a TNPP being delivered to the prepared site of FIG. 4A.

FIG. 4C depicts a side view and a top view of a TNPP that has been moved to its operational position at the prepared site of FIG. 4A.

FIG. 5A depicts two stages of a delivery of a TNPP by a two-hulled vessel to a quay.

FIG. 5B is a transverse cross-sectional view of the TNPP of FIG. 5A in a first stage of delivery.

FIG. 5C is a transverse cross-sectional view of the TNPP of FIG. 5A in a second stage of delivery.

FIG. 6A depicts a TNPP that has been moved to a prepared site but is not yet self-supporting.

FIG. 6B depicts the TNPP of FIG. 6A after it has become self-supporting.

FIG. 7 depicts a TNPP made operational by equipping it with an SMR and connecting its electrical output to transmission lines.

FIG. 8 depicts a side view and a top view of an operational TNPP at a site that offers enhanced airstrike protection by means of a swale.

FIG. 9 depicts a side view and a top view of an operational TNPP at a site that offers enhanced airstrike protection by means of a swale and a berm.

FIG. 10 depicts an operational TNPP at a site that offers enhanced airstrike protection by means of a reactor silo.

FIG. 11 depicts various degrees of airstrike protection afforded to a TNPP by a flat site, swale, berm, SMR vault, and mountainous terrain.

### DETAILED DESCRIPTION OF EMBODIMENT(S) OF THE INVENTION

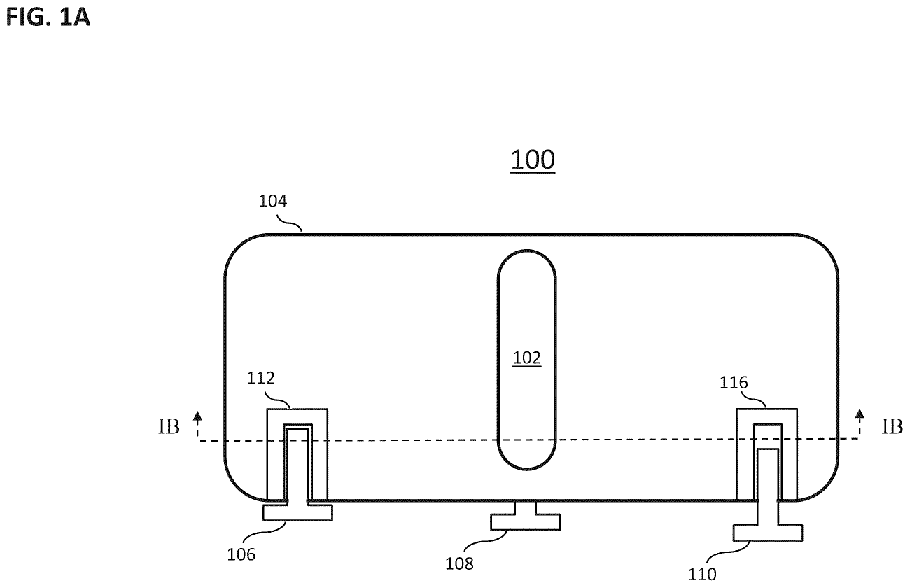

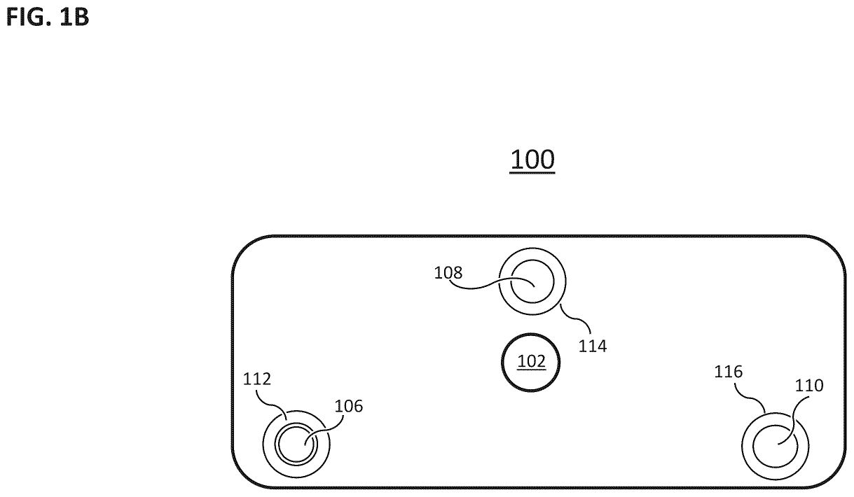

FIG. 1A schematically depicts a transportable nuclear power plant (TNPP) 100 in longitudinal cross-section according to an illustrative embodiment of the invention.

FIG. 1B depicts the TNPP 100 of FIG. 1A in transverse cross-section at the broken line IB-IB.

Referring now to FIG. 1A, the TNPP 100, which is preferably built at a shipyard, comprises an SMR 102 in a civil structure 104 and one or more support mechanisms with vertically adjustable supports 106, 108, 110. Three depicted and each adjustable support, e.g., support 106, can be moved vertically within a housing, e.g., housing 112, that is coupled to the civil structure 104. The TNPP 100 also preferably comprises, according to the prior art of nuclear power generation, power conversion systems and the various safety, security, and other operational measures necessary to make the TNPP 100 a standalone source of electricity and/or thermal energy, but these systems are for simplicity not depicted in FIG. 1A or other Figures herein.

Each of the three supports 106, 108, 110 can be extended or retracted independently of the others even while the supports collectively support the full weight of the TNPP 100; in FIG. 1A, each support is illustratively extended to a different extent.

Preferably, when the TNPP 100 is installed at an operational location, the degree of extension of each support is adjusted so that the overall degree of tilt of the TNPP 100 remains within the acceptable operational limits for tilt of the SMR 102 and all other systems comprised by the TNPP 100. In short, the supports 106, 108, 110 and their respective housings constitute a system for adaptively leveling the TNPP 100, as for example to accommodate dynamic ground movements. Self-leveling of the TNPP 100 preferably occurs automatically in response to any new deviation from the level that exceeds some threshold fraction (e.g., 1%) of the tilt tolerance of the least tilt-tolerant subsystem (e.g., SMR) comprised by the TNPP 100. If automatic self-leveling fails to restore the TNPP 100 to the acceptable tilt range, an alarm is given. A variety of such self-leveling systems are known to the prior art, such as those used to maintain optical tables near the level.

TNPP supports 106, 108, 110 depicted in FIG. 1A and other Figures herein are represented in a simplified form to indicate their basic functionality rather than any specific mechanism of operation. Various specific mechanisms and principles of operation of such supports are contemplated in various embodiments of the invention, including hydraulic and mechanical jacking systems known to the art of civil engineering. Preferably, the adjustable supports 106, 108, 110 and all other such supports depicted in Figures herein are constructed so that they lock in place if electrical, mechanical, hydraulic, or any or all other forms of power or control input employed by their mechanism is lost at any time. That is, the supports 106, 108, 110 and all other such supports depicted herein are preferably failsafe against collapsing into their housings. Moreover, the supports 106, 108, 110 may in various embodiments be protected by a structural skirt attached to the TNPP physically protecting space between the ground and the TNPP. The supports 106, 108, 110 may in various embodiments be supplemented by additional structural supports that are capable of being removed or adjusted.

FIG. 1B depicts a schematic cross-section of the TNPP 100 at the broken line IB-IB of FIG. 1A, clarifying the relation of the SMR 102 and the adjustable supports to the TNPP 100 as a whole. The supports (e.g., support 106) are arranged in a triangular pattern; it will be clear that this arrangement provides sufficient degrees of freedom to level the TNPP 100. Visible in the cross-sectional view of FIG. 1B are the SMR 102, the support 106 and its housing 112, a second housing 114, and a third housing 116.

Although a single SMR and three adjustable supports are depicted in FIG. 1A, FIG. 1B, and other Figures herein, these provisions are illustrative, not selective. Larger numbers of SMRs and of supports, and various arrangements of these elements with respect to the TNPP 100, which may in various embodiments have a different form than that depicted in the Figures herein, are also contemplated and within the scope of the invention.

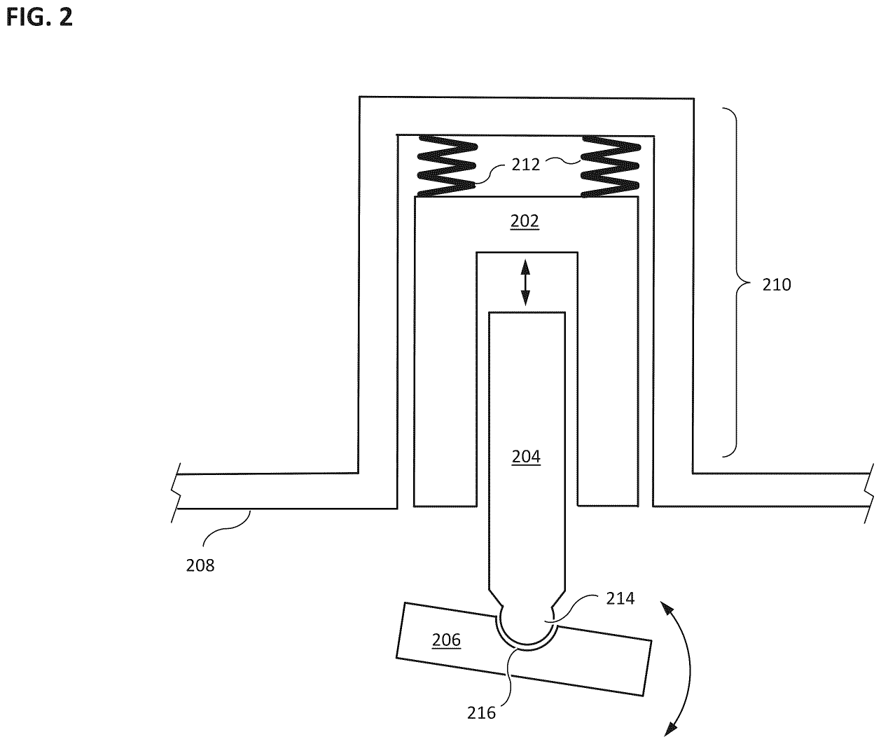

FIG. 2 schematically depicts, in simplified functional form, a TNPP support mechanism that is comprised by a TNPP civil structure 208 according to an illustrative embodiment of the invention. Only a portion of the civil structure 208 is depicted. The support mechanism incorporates provisions for vertical adjustment, seismic isolation, and accommodation of tilted nether load-bearing surfaces. Such a support mechanism enables a TNPP to be stably installed in a wider range of environments than a support mechanism capable of vertical adjustment only, for example, an environment subject to significant seismic shocks and/or to displacement of supportive footings embedded in permafrost. The support mechanism may act as locating pins to position the TNPP in its exact location upon arrival and comprises a housing 202, a support member 204, and foot 206.

The housing 202 is set into a load-bearing well or socket 210 which is integral with the civil structure 208. The housing 202 is coupled to the load-bearing well 210 of the civil structure 208 by a seismic isolation mechanism 212 (e.g., springs, hydraulic and/or any other dampening and/or seismic isolation method known in the prior art) which mitigates the transmission of shocks from the support mechanism to the structure 208. Moreover, the support member 204 is coupled to the foot 206 by a coupling, e.g., for illustrative purposed depicted comprising a ball 214 and socket 216. This coupling provides limited angular freedom of movement to the foot 206. In various embodiments, TNPPs are preferably equipped with support mechanisms providing seismic isolation and accommodating angular displacement of supportive footings, whether by the means depicted in FIG. 2 or by others.

Also in various embodiments, more than three support mechanisms are employed, as for example one support mechanism at each corner of an TNPP having a rectangular footprint. Larger numbers of support mechanisms can confer additional stability and/or backup leveling capability to enable leveling during failure or servicing of other support mechanisms.

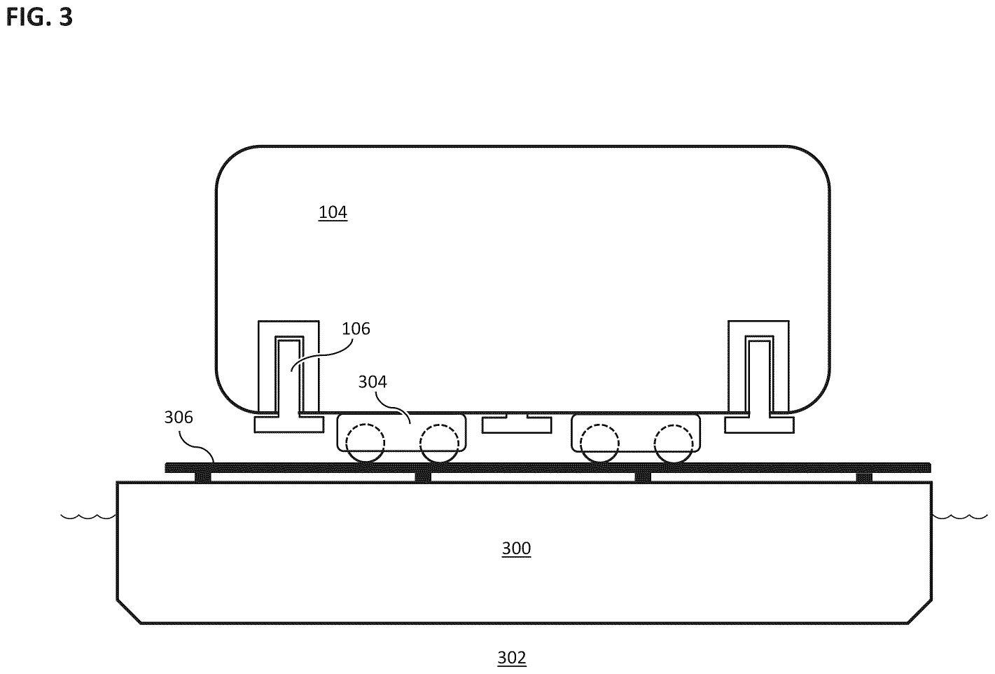

FIG. 3 is a cross-sectional schematic depiction of portions of the TNPP 100 of FIG. 1A, according to an illustrative embodiment, that has been loaded aboard a transport vessel 300 floating in a body of water 302. The transport vessel 300 may be a self-propelled heavy transport vessel or a barge moved by a self-propelled vessel (not depicted).

The civil structure 104 preferably does not contain a fueled SMR during transport. In various embodiments, it contains no SMR, an unfueled, non-radioactive SMR that is subsequently fueled after installation at the TNPP's service location, or a factory fueled SMR. Load-out of the structure 104 onto the vessel 300 has been accomplished using methods familiar to the art of marine transport of large, prefabricated structures such as offshore platforms.

Herein, the term “load-out” denotes the transfer of a major assembly onto a barge by horizontal movement; or by lifting; or by ballasting a vessel down, positioning it under the assembly in question, and then ballasting the vessel up to lift the assembly. These are other methods of loading a large assembly aboard a transport vessel, and corresponding methods of unloading such an assembly, are known to the art of maritime transport, and all such methods are contemplated and within the scope of the invention.

In this case, the civil structure 104 is supported upon and moved by a number of self-propelled modular transporters (SPMTs), e.g., SPMT 304. The SPMTs move upon tracks or pathways, e.g., track 306. During load-out, the structure 104 is moved by SPMTs on tracks across a quay (not depicted) and thence to the deck of the vessel 300; standard techniques are used to keep the structure 104 level and the deck level of the vessel 300 aligned sufficiently closely with the surface of the quay. During transport, the supports (e.g., support 106) are withdrawn into the internal housings so as to present no obstacle to horizontal movement of the TNPP 100. In various embodiments, withdrawal of the supports into the body of the TNPP 100 can be complete, leaving no external obstacle to horizontal movement.

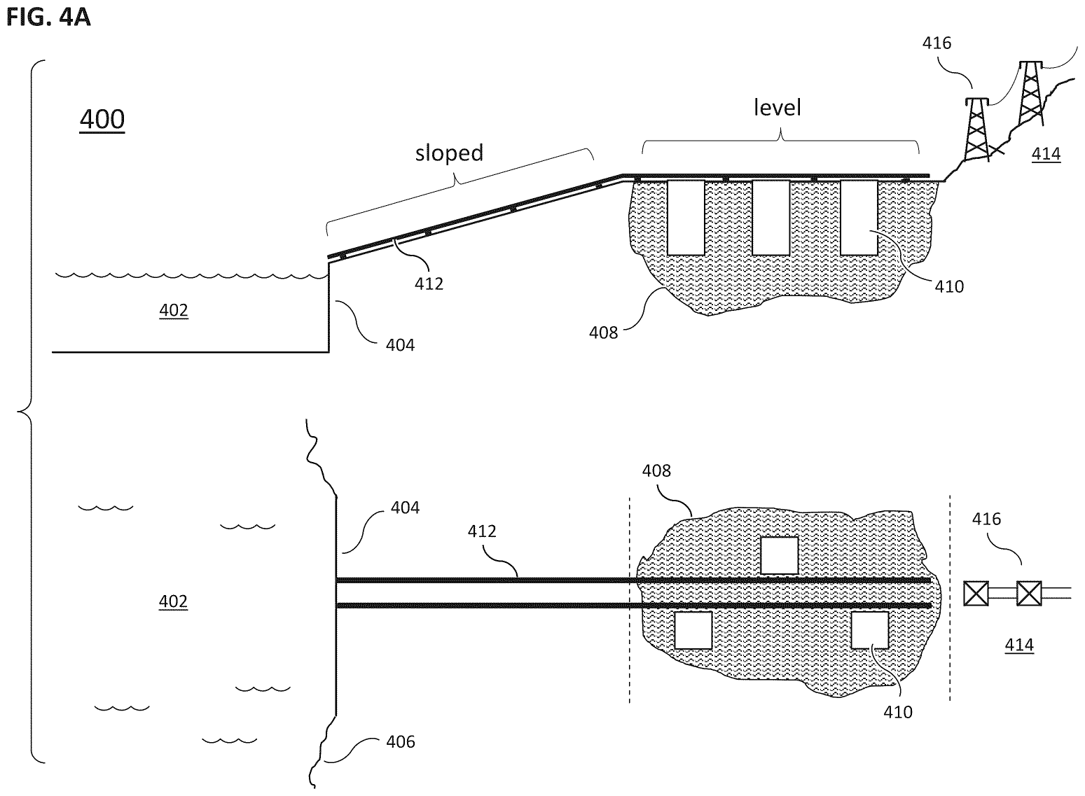

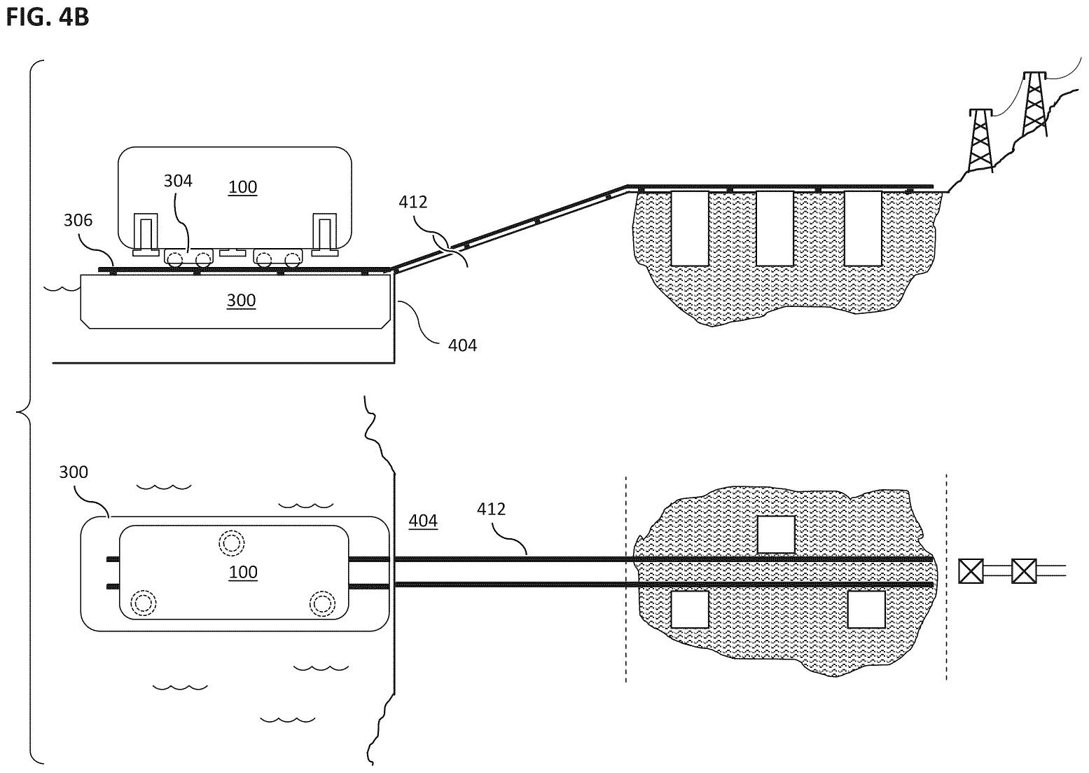

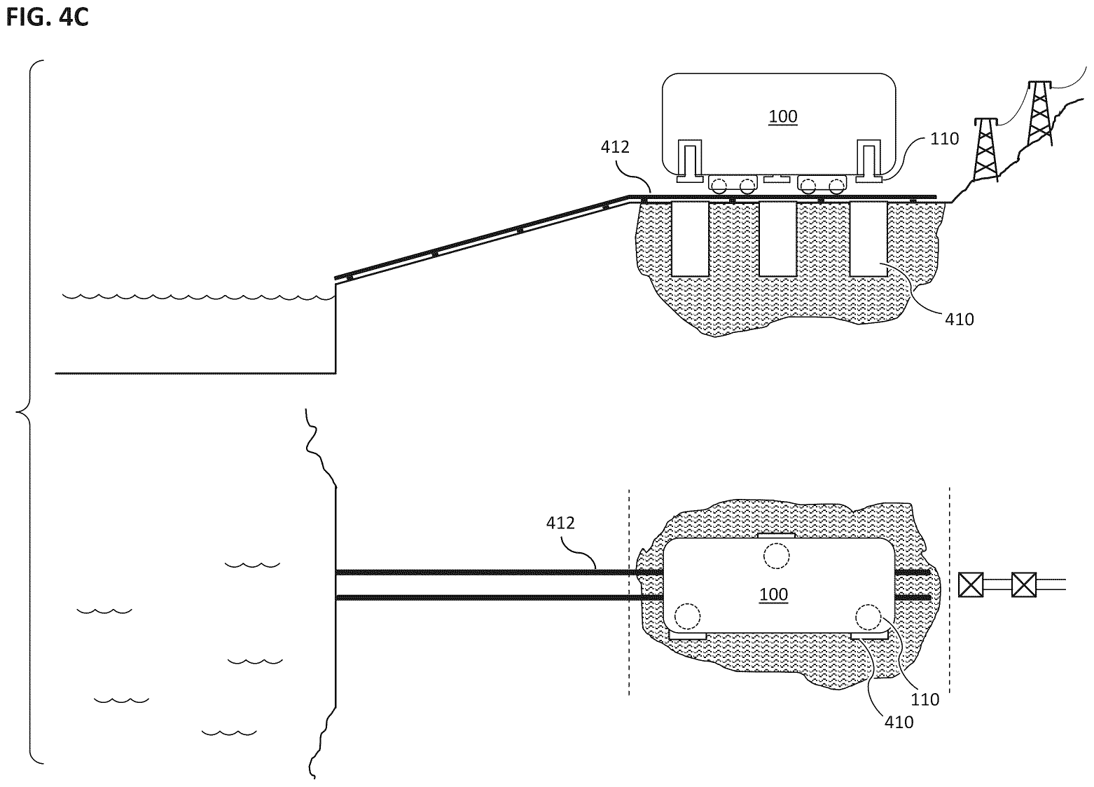

FIG. 4A is a schematic depiction in vertical cross-section (upper drawing) and plan view (lower drawing) of portions of an illustrative coastal site 400 prepared for the installation of a TNPP 100 according to an illustrative embodiment of the invention. The coastal site 400 comprises a body of water (e.g., ocean) 402, a quay 404 which modifies or replaces a portion of a natural shoreline 406, and a region of land that slopes up from the quayside to a naturally level or artificially leveled area where the TNPP 100 is to be installed.

The level TNPP installation area is underlain by unstable grounds, e.g., swamp or permafrost. The TNPP deployment location requires geotechnical ground improvements 408 to increase bearing capacity, here depicted as a limited region for clarity but may vary based on site-specific conditions. At least one, (three depicted) supportive footings, e.g., footing 410, are embedded in the permafrost, having been installed using one of the methods familiar to the art of civil engineering, including civil engineering methods specific to Arctic and other regions of extreme or unstable terrain. Rails 412 suitable for carrying the load of a TNPP 100 moved by SPMTs 304 or other means ascend the slope to the level area, passing amidst the footings 410. In various other embodiments, the rails 412 are replaced by load-bearing plates or other provisions, preferably removable, for supporting movement of a TNPP 100.

A mountainous natural landform 414 ascends on the inland side of the level area. Electrical transmission lines 416 stand ready to be connected to a TNPP 100 and deliver power to a grid or dedicated consumer. Tower-supported transmission lines are depicted in FIG. 4A, but in various embodiments transmission lines may alternatively or additionally be laid on the surface, buried in trenches, or installed in other ways known to the art of electrical transmission systems.

Vertical scale has been exaggerated in FIG. 4A. In the plan view of FIG. 4A and plan views of subsequent Figures, dashed lines indicate inflections in the slope of the land surface.

Preferably, the level area comprising the footings for supporting a TNPP 100 (e.g., footing 410) is sufficiently above sea level to provide protection against severe weather and ocean events, e.g., such as tsunamis and sea-level rise, in agreement with relevant standards and regulations for locating a nuclear power plant. The forms and types of all natural and artificial features of the site 400 are illustrative only; there is no restriction to installation sites possessing these features, or to these arrangements of features.

FIG. 4B depicts the site 400 of FIG. 4A with a TNPP 100 at the quay 404 aboard a transport vessel 300. The vessel 300 is ballasted so that the SPMT tracks 306 of the vessel 300 are aligned sufficiently closely with the SPMT tracks 412 of the prepared site to enable offloading of the TNPP 100.

As the weight of the TNPP 100 is transferred from the vessel 300 to the quay 404 by the SPMTs (e.g., SPMT 304), dynamic ballasting systems of the vessel 300 are adjusted to keep the deck of the vessel 300 sufficiently closely aligned at all times to the surface of the quay 404 to permit transfer of the TNPP 100.

FIG. 4C depicts the site 400 of FIG. 4A with the TNPP 100 delivered to the level area but not yet installed. The feet of the three locating pins and support mechanisms of the TNPP 100 (e.g., foot 110) are aligned with the three footings (e.g., footing 410) but not yet in contact with them. In the state of affairs depicted in FIG. 4C, the TNPP 100 is still supported by SPMTs 304 upon the rails 412. For typical coastal sites, the ground surface beneath the rails 412 must be modified, using methods familiar in the art of civil engineering, to bear the weight of the TNPP 100 during installation at the site; for simplicity, such modifications are omitted from the Figures herein.

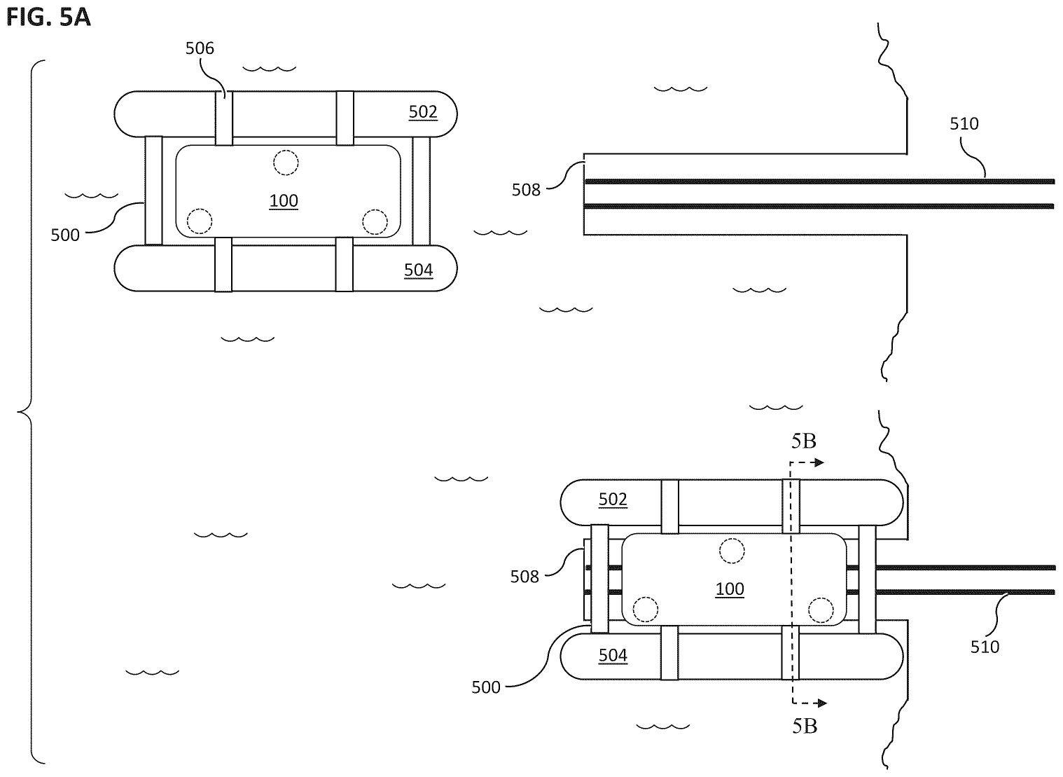

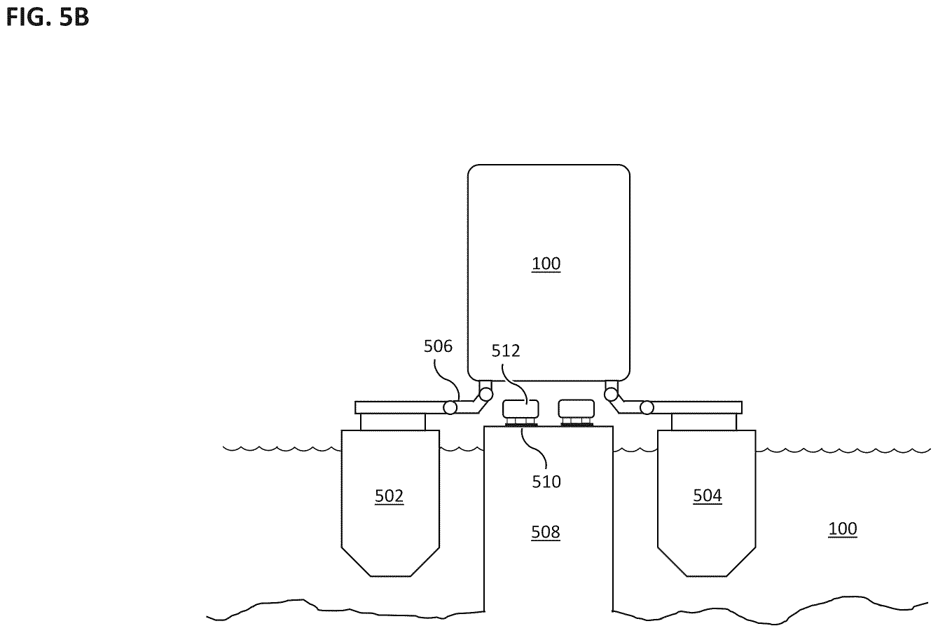

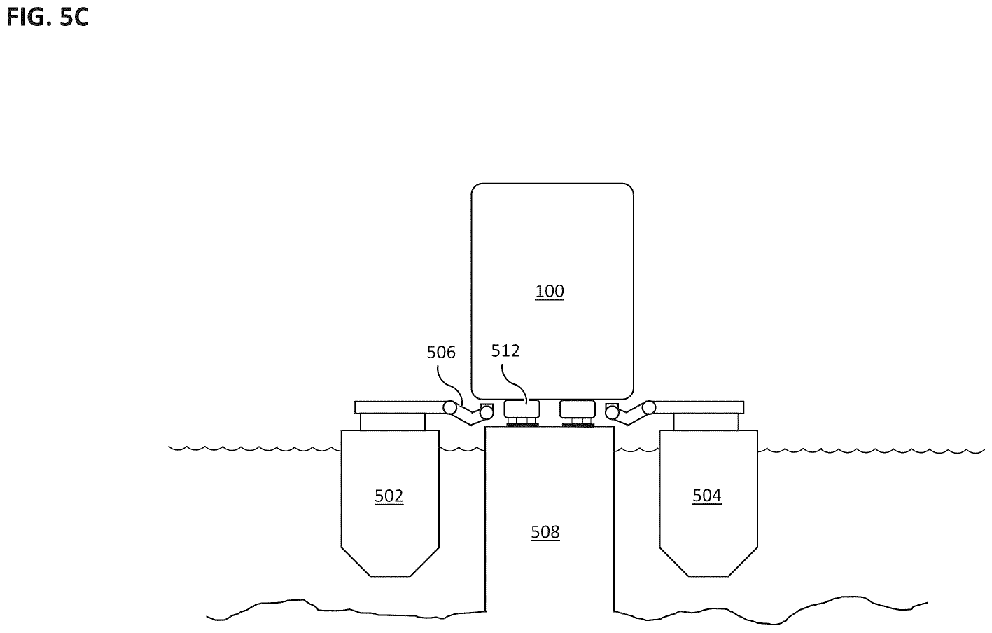

FIG. 5A depicts in schematic plan view a TNPP 100 in two stages of delivery to a prepared coastal site according to another illustrative embodiment. The TNPP 100 is borne by a ship 500 with two parallel hulls 502, 504, being upheld between the two hulls 502, 504 by at least four lateral supports (e.g., lateral support 506). Similar vessels are known to the art of maritime transport, as for example the Pioneering Spirit of Allseas, Inc.

The prepared site comprises a protruding quay 508 upon which are laid tracks 510, similar to the track 412 of FIG. 4A, which lead to an installation site (not depicted) for the TNPP 100. The quay 508 is sufficiently narrow so that the two hulls 502, 504 can bracket the quay 508, and the vessel 500 is ballasted so that the TNPP 100 can clear the upper surface of the quay 508. In the first stage of delivery (upper portion of the drawing), the vessel 500 approaches the quay 508. In a second stage of delivery (lower portion of the drawing), the vessel 500 straddles the quay 508 so that the TNPP 100 is directly above the tracks 510.

FIG. 5B depicts the TNPP 100 of FIG. 5A in transverse cross-section at the broken line 5B-5B in the second stage of delivery. Two of the four transverse members (e.g., transverse member 506) that support the TNPP are depicted. Also, a number of SPMTs (e.g., SPMT 512) are depicted as having been positioned on the tracks 510 below the TNPP 100.

FIG. 5C depicts the TNPP 100 of FIG. 5B in a third stage of delivery. In this stage, the vessel 500 has been ballasted down so that the TNPP 100 has been deposited upon the SPMTs 512 and the lateral support members are no longer in contact with the TNPP 100. In a stage of delivery subsequent to that depicted in FIG. 5C, the vessel 500 is moved away from the quay 508.

In various embodiments, and depending on siting and power generating technology requirements, the protruding quay 508 functions as the final TNPP installation site (not depicted). Alternatively, the TNPP 100 is transported by the SPMTs 512 to an installation site in a manner similar to that described with reference to FIG. 4B and FIG. 4C.

It will be clear that a process similar to that depicted in FIG. 5A, FIG. 5B, and FIG. 5C may be used in reverse to lift a TNPP 100 off a quay 508 for transport to another location. It will also be clear that other methods known to the art of maritime transport may be employed, additionally or alternatively to those described with reference to FIG. 5A, FIG. 5B, and FIG. 5C; for example, lateral supports equipped with hydraulic lifters could be used to lower an TNPP 100 onto a quay 508 or raise it therefrom, additionally or alternatively to vertical movement via ship ballasting.

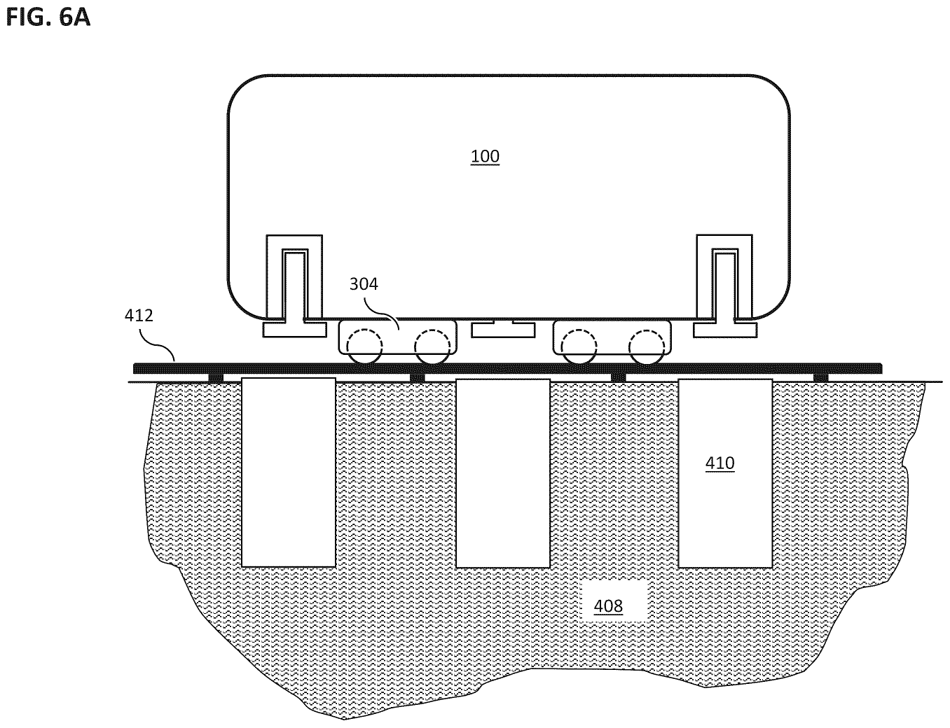

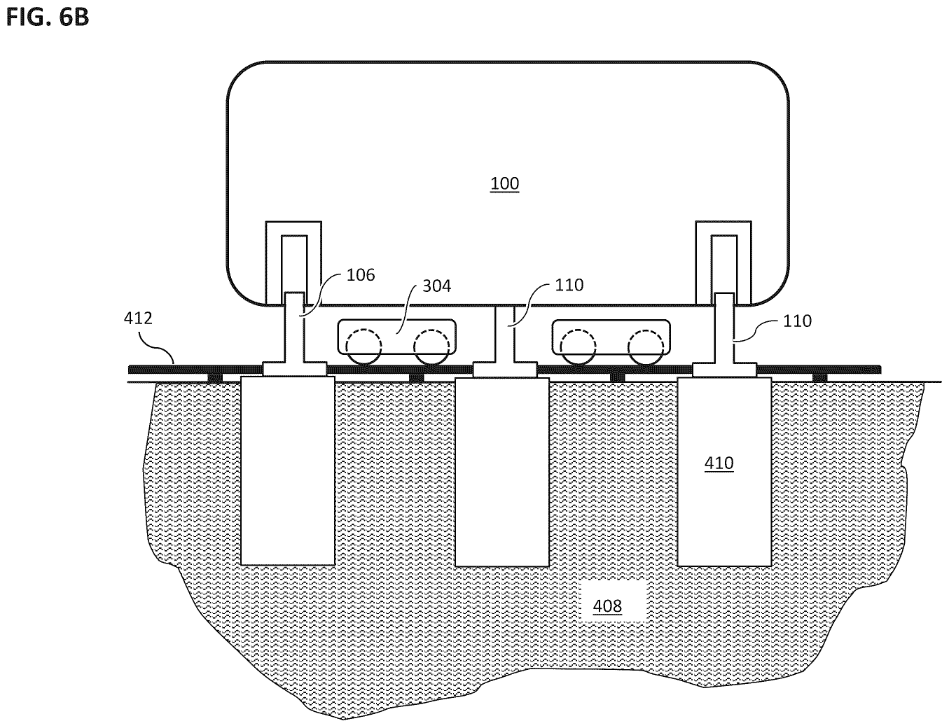

FIG. 6A is a detailed view of the state of a TNPP 100 delivered to its installation site, as for example, the installation site depicted in FIG. 4C. The TNPP 100 has been moved to its level operational site but still rests upon the SPMTS (e.g., SPMT 304), which in turn are supported by the rails 412.

FIG. 6B depicts the state of the TNPP 100 of FIG. 4C after its supports have been extended to transfer the weight of the TNPP 100 from the SPMTs to the footings. The supports have been lengthened sufficiently to raise the TNPP 100 from the SPMTs, which are now free to move along the rails 412 and be loaded back onto the vessel 300 of FIG. 4B.

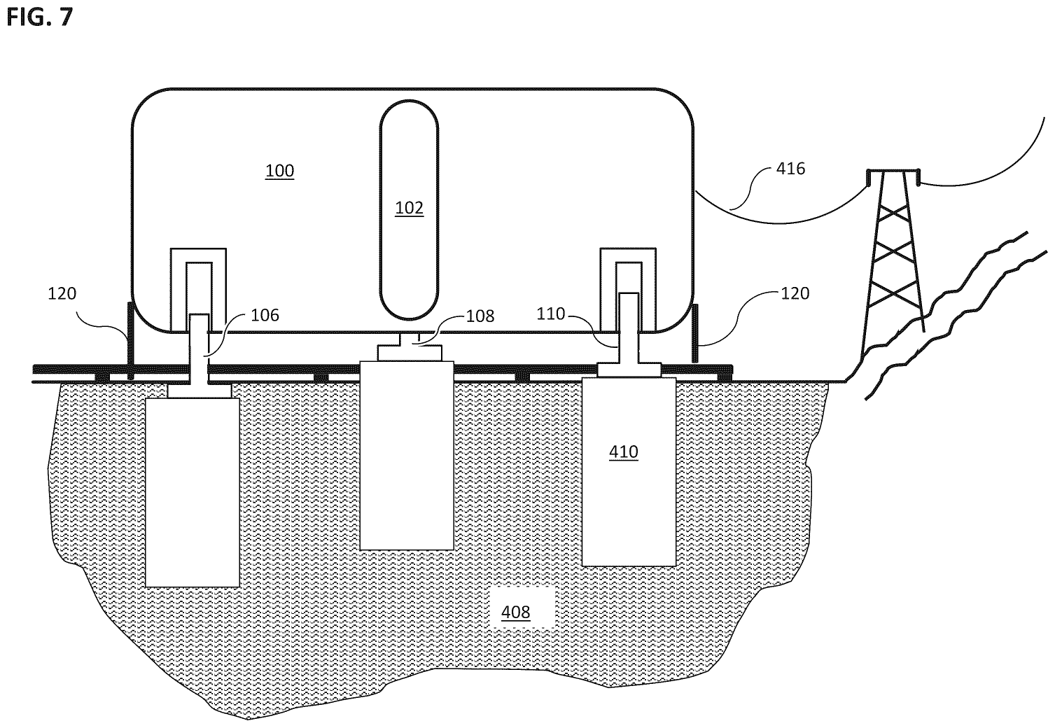

FIG. 7 schematically depicts the illustrative TNPP 100 of FIG. 1 as fully installed and functional according to an illustrative embodiment.

It should be understood that, in one contemplated embodiment, an SMR 102 will be delivered separately to the TNPP 100 and installed therein. The SMR 102 delivers heat to power-generation systems in the TNPP 100.

In various other embodiments, an unfueled, non-radioactive SMR 102 is delivered within a TNPP 100 to an installation site and fueled, in situ, after installation: other sequences of delivery and fueling of SMRs are contemplated and within the scope of the invention.

Power from the TNPP 100 is delivered to consumers via the transmission line 416.

The adjustable supports of the TNPP 100 (e.g., support 110) have been variously extended and withdrawn to keep the TNPP adequately level despite vertical movement of the footings (e.g., footing 410) in the ground. In addition, in this embodiment, a skirt 120 has been added around the periphery of the TNPP 100 to restrict access to the supports 110.

Vertical footing displacement alone has been depicted, but angular displacement is also possible, and would in various embodiments be accommodated by TNPP supportive mechanisms such as, for example, that of FIG. 2.

Of note, in the state of affairs depicted in FIG. 7, the supporting transfer and transport systems, e.g., rails, on the sloping portion of the prepared site 400 of FIG. 4A (not depicted) have been removed after installation of the SMR 102. Supporting transfer and transport systems removal greatly increases the difficulty of removing the SMR 102 or the TNPP 100 as a whole from the site 400 by, for example, terrorists. Although new rails or other prepared surfaces could be laid by an unauthorized party, specialized gear and significant time would be required for such an undertaking, making its interdiction more feasible.

Post-installation removal of the rails connecting the level installation site to the quayside is thus a security measure which deters or impedes any unauthorized effort to remove the TNPP 100, despite its ultimate portability, or to remove one or more of the SMRs 102 comprised by the TNPP 100.

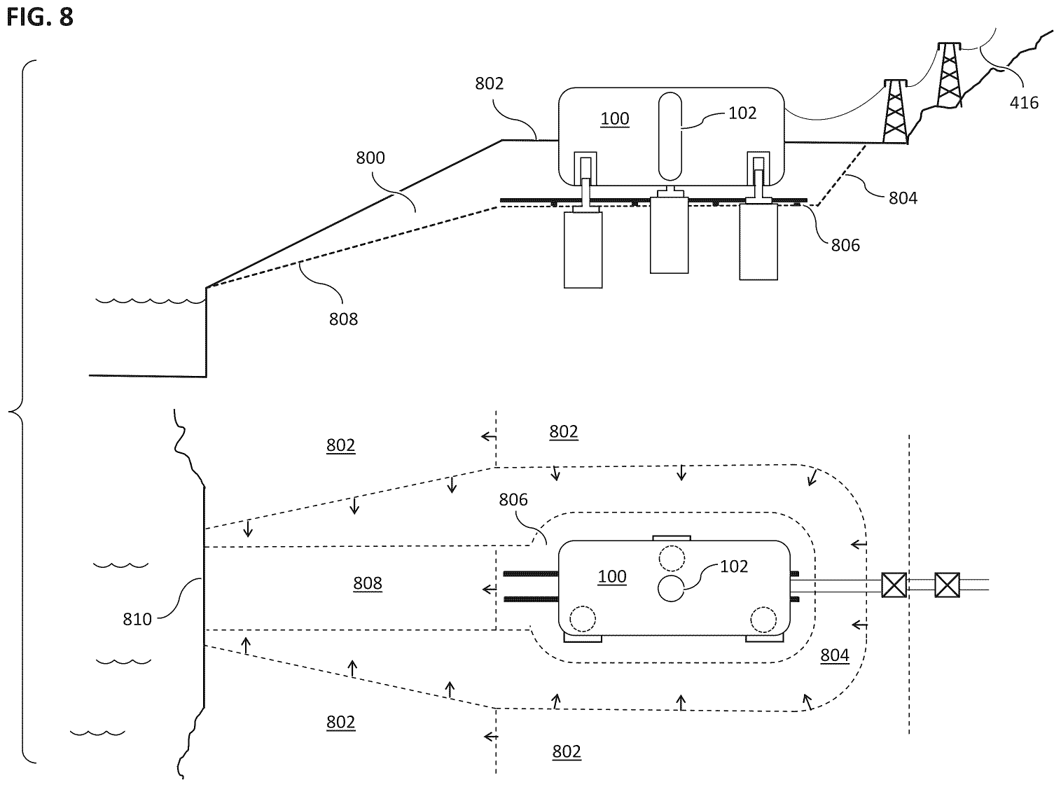

FIG. 8 is a schematic depiction in vertical cross-section (upper portion of the drawing) and plan view (lower portion of the drawing) of portions of a coastal installation of a TNPP 100 according to another illustrative embodiment.

The installation of FIG. 8 is similar to that of FIG. 6 but with the distinction that the TNPP 100 is inset in a trench, depression, or swale 800. The swale 800 is cut below the grade level 802 of the installation site and comprises slanting (e.g., 3:1) side slopes, e.g., side slope 804. In the plan view of FIG. 8, dashed lines indicate inflections in the slope of the land surface and small arrows attached to the dashed lines denote the side of the line on which land slopes downhill (if either slope at the inflection does slope downhill). The TNPP 100 rests on a level area 806, i.e., the floor of the swale 800, and a planar ramp 808 declines from the level area 806 to the quayside 810.

The swale 800 is of sufficient depth that a significant portion of the SMR 102 comprised by the TNPP 100 is below the grade level 802 in the vicinity of the TNPP 100. In FIG. 8, approximately half of the SMR 102 is below grade 802.

It should be apparent to those skilled in the art that the arrangement of FIG. 8 constrains routes of approach by aircraft to the TNPP 100 and the SMR 102 to steeper angles and/or to a single bearing aligned with the ramp 808, and that the TNPP 100 in the setting of FIG. 8 is, thus, more secure against attack than in the setting of FIG. 4C. It will also be clear that the deeper the swale 800, the more protection it afforded to the TNPP 100.

Of note, in the state of affairs depicted in FIG. 8, the rails on the ramp 808 have been removed after installation of the SMR 102, obtaining the security advantages described herein with reference to FIG. 8, in addition to those conferred by the swale 800.

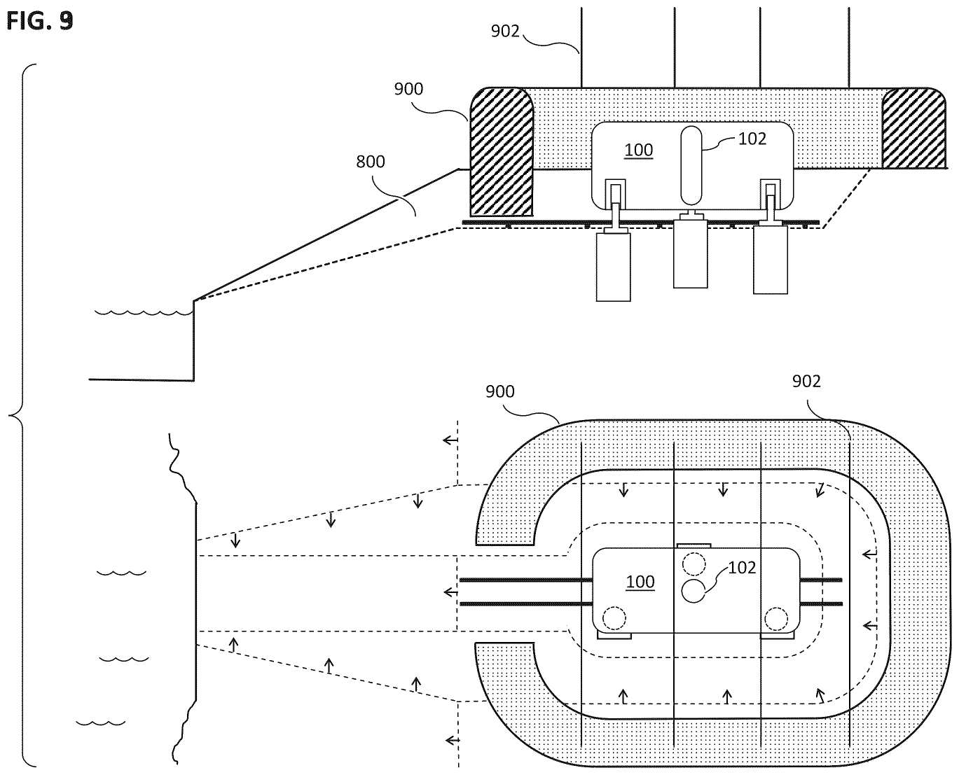

FIG. 9 is a schematic depiction in vertical cross-section (upper portion of the drawing) and plan view (lower portion of the drawing) of portions of an illustrative coastal installation of a TNPP 100 according to still another illustrative embodiment.

The installation of FIG. 9 is similar to that of FIG. 8, but with the distinction that, in addition to setting the TNPP 100 in a swale 800, a berm 900 has been erected around the TNPP 100. In various embodiments, a berm, such as the berm 900, may be advantageously constructed, in whole or part, from material excavated to produce a protective swale 800 such as that depicted in FIG. 8, or from local or regional material, such as tailings from a mining operation, that is delivered to the TNPP installation site.

In the plan view of FIG. 9, dashed lines indicate inflections in the slope of the land surface and small arrows attached to the dashed lines denote down-sloping land. The berm 900 further constrains angles of approach of aircraft to the TNPP 100 and the SMR 102. It will be clear that the taller the berm 900 and the closer it is to the TNPP 100, the more it will constrain angles of approach of aircraft.

Deepening the swale 800, increasing the height of the berm 900, or both have the effect of more severely constraining angles of approach of aircraft to the TNPP 100.

In various embodiments, a berm 900 may be erected around a TNPP 100 that is not set into a swale 800. In deployments where the elevation of a coastal TNPP site is not sufficiently far above sea level to allow a TNPP to be set into a swale while still being sufficiently elevated to be secure against tsunamis, a swale will not typically be employed. Preferably, absolute elevation of the TNPP 100 in an installation is sufficient to lower tsunami risk to an acceptable level, while the depth of any protective swale and/or the height of any protective berm is sufficient to reduce aircraft impact risk to an acceptable level.

As also shown in FIG. 9, one or more arches 902 may be constructed to extend from one side of the berm 900 to the other side. The arches 902 are contemplated to extend above the TNPP 100. The arches 902 are provided to absorb the impact forces from, for example, an aircraft and, thereby, to enhance the security surrounding and/or associated with the TNPP 100. As should be apparent, the arches 902 may extend from one side of the berm 900 to the other. Of course, the arches 902 may be constructed to extend diagonally across the TNPP 100 to connect adjacent sides of the berm 900 in an alternate construction. In addition, while the arches 902 are illustrated as inverted U-shaped structures, the arches 902 may have any shape without departing from the scope of the present invention. In one contemplated embodiment, for example, the walls of the berm 900 may be constructed with a sufficient height so that the arches 900 are constructed as beams (e.g., linear elements) that extend between the sides of the berm 900, above the TNPP 100.

In summary, the arches 902 are provided as a series of structural elements that may be erected on or in close proximity to the exterior of the TNPP 100 for the purposes of absorbing or dissipating energy and preventing build-up of debris as a result of accidental or intentional missile impacts, which include aircraft crashes. Therefore, the discussion of the arches 902 as inverted U-shaped elements should not be considered as a limiting variable with respect to these structures.

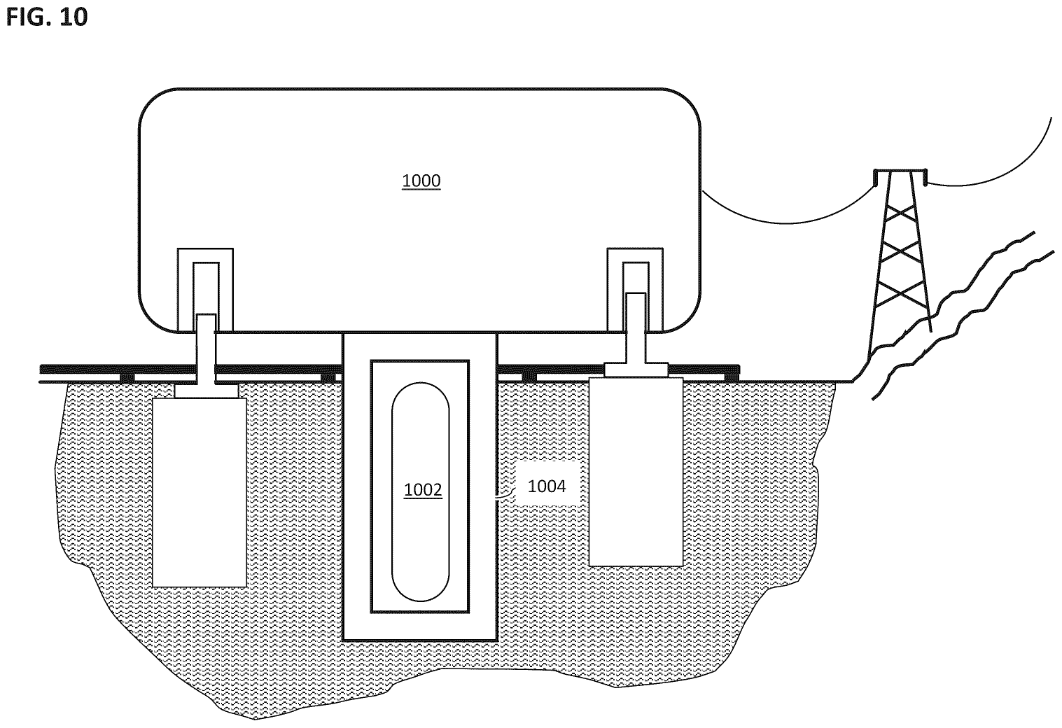

FIG. 10 is a schematic depiction in vertical cross-section of portions of an illustrative coastal installation of a TNPP 1000 according to yet another illustrative embodiment. In the installation of FIG. 10, there is no swale or berm, but the SMR 1002 is housed entirely below grade in a vault 1004, which is a vertically-oriented shaft below a grade level of the installation. Non-nuclear facilities and mechanisms are housed in the TNPP 1000. Angles of approach by aircraft to the civil structure of the TNPP 1000 are unconstrained, but angles of approach to the SMR 1002 are constrained to the near-vertical when a vault 1004 is employed, as illustrated. By the addition of a swale and/or berm, angles of approach to the TNPP civil structure could also be constrained.

In various embodiments of the invention, the below grade deployment in a vault can be achieved by integrating a vertical shaft into the protruding quay 508 (FIG. 5A, 5B, 5C) for TNPP siting.

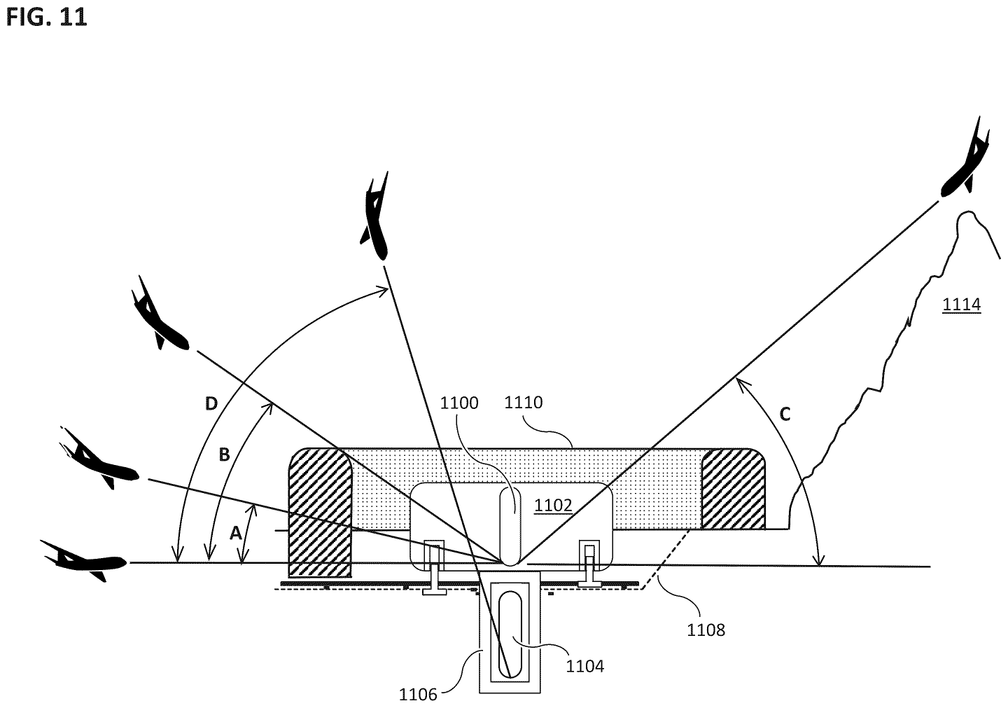

FIG. 11 is a schematic depiction in cross-section of the relative degrees of constraint imposed on angles of approach of aircraft to an SMR 1100 comprised by a TNPP 1102, or to an SMR 1104 enclosed in a vault 1106, by the protective provisions of various illustrative embodiments. Without a vault, swale, or berm, aircraft can approach horizontally (least constraint).

A swale 1108 constraints the vertical angle of approach to be greater than an angle A whose value is determined by the depth and width of the swale 1108. A berm 1110 constrains the angle of approach to be greater than an angle B, typically greater than angle A, whose value is determined by the height and width of the berm 1110 and the depth and width of the swale 1108. A nearby natural landscape feature such as a mountain range 1114 can constrain the angle of approach from some bearings to an angle C that may be greater or less than the angles A or B. Finally, a vault 1106 constrains the angle of approach to an angle D that is close to 90°. It will be clear that any combination of protective arrangements may be employed by various embodiments.

In various embodiments, it is preferable that, when an SMR comprised by a TNPP requires refueling, the SMR may either be refueled in situ (within the TNPP), at a nearby staging site, or may be swapped out for a freshly fueled SMR. All such arrangements and procedures are contemplated and within the scope of the invention.

The foregoing has been a detailed description of illustrative embodiments of the invention. Various modifications and additions can be made without departing from the spirit and scope of this invention. Each of the various embodiments described above may be combined with other embodiments in order to provide multiple features. Any of the abovementioned embodiments can be deployed on or along a natural or man-made coastline, or on a natural or artificial island, or on a floating or stationary marine platform, or underwater.

Furthermore, while the foregoing describes a number of separate embodiments of the apparatus and method of the present invention, what has been described herein is merely illustrative of the application of the principles of the present invention. Accordingly, this description is meant to be taken only by way of example, and not to limit the scope of this invention.

What is claimed is:

1. A method for installing a transportable nuclear power plant at a site, comprising:
depositing the transportable nuclear power plant on a marine vehicle, wherein the transportable nuclear power plant comprises at least one adjustable support;
transporting the transportable nuclear power plant, via the marine vehicle, to a quay, wherein the quay provides access to an installation site on land;
transitioning the transportable nuclear power plant from the marine vehicle to at least one land vehicle;
transporting the transportable nuclear power plant to the installation site via the at least one land vehicle; and
deploying the at least one adjustable support from the transportable nuclear power plant at the installation site.

2. The method of claim 1, wherein the at least one adjustable support comprises three adjustable supports.

3. The method of claim 1, further comprising:
digging a swale around the installation site, thereby positioning the transportable nuclear power plant at least partially below a grade level,
wherein the swale reduces an angle of attack of the installation site from airborne threats.

4. The method of claim 1, further comprising:
building a berm around the installation site,
wherein the berm extends above a grade level, and
wherein the berm reduces an angle of attack of the installation site from airborne threats.

5. The method of claim 1, further comprising:
digging a vault beneath the transportable nuclear power plant, wherein the vault is below a grade level,
lowering a small modular reactor from the transportable nuclear power plant into the vault,
wherein the vault reduces an angle of attack of the installation site from airborne threats.

6. The method of claim 4, further comprising:
building a berm around the swale,
wherein the berm extends above a grade level, and
wherein, when compared to the swale alone, the berm further reduces the angle of attack of the installation site from airborne threats.

7. The method of claim 3, further comprising:
digging a vault beneath the transportable nuclear power plant, wherein the vault is below a grade level,
lowering a small modular reactor from the transportable nuclear power plant into the vault,
wherein the vault reduces an angle of attack of the installation site from airborne threats, and
wherein, when compared to the berm alone, the vault further reduces the angle of attack of the installation site from airborne threats.

8. The method of claim 4, further comprising:
digging a vault beneath the transportable nuclear power plant, wherein the vault is below a grade level,
lowering a small modular reactor from the transportable nuclear power plant into the vault,
wherein the vault reduces an angle of attack of the installation site from airborne threats, and
wherein, when compared to the swale alone, the vault further reduces the angle of attack of the installation site from airborne threats.

9. The method of claim 6, further comprising:
digging a vault beneath the transportable nuclear power plant, wherein the vault is below a grade level,
lowering a small modular reactor from the transportable nuclear power plant into the vault,
wherein the vault reduces an angle of attack of the installation site from airborne threats, and
wherein, when compared to the berm and swale, the vault further reduces the angle of attack of the installation site from airborne threats.

10. The method of claim 4, further comprising:
building at least one arch atop the berm between opposing sides thereof, wherein the at least one arch extends above the transportable nuclear power plant.

11. A transportable nuclear power plant, comprising:
a civil structure adapted to contain at least one nuclear reactor therein;
at least three adjustable supports disposed beneath the civil structure, wherein the at least three adjustable supports are deployable from the civil structure to level the civil structure at an installation location for the transportable nuclear power plant.

12. A system for delivering a transportable nuclear power plant to an installation site, comprising:
a civil structure adapted to contain a nuclear reactor, wherein the civil structure is transportable from a first location to the installation site;
a marine vessel adapted to receive and transport the civil structure across a body of water; and
at least one land vehicle adapted to receive the civil structure from the marine vessel and to transport the civil structure to the installation location.

13. The system of claim 12, wherein:
the at least one land vehicle is a self-propelled modular transporter.

14. The system of claim 12, wherein the civil structure comprises:
at least one adjustable support deployable from beneath the civil structure to level the civil structure at the installation location.

15. The system of claim 14, wherein the at least one adjustable support comprises at least three adjustable supports.

16. The system of claim 12, wherein the installation location comprises a swale around the installation site, thereby positioning the transportable nuclear power plant at least partially below a grade level,
wherein the swale reduces an angle of attack of the installation site from airborne threats.

17. The system of claim 12, wherein:
the installation location comprises a berm around the installation site,
the berm extends above a grade level, and
the berm reduces an angle of attack of the installation site from airborne threats.

18. The system of claim 12, wherein:
the installation location comprises a vault beneath the transportable nuclear power plant into which a small modular reactor may be lowered from the transportable nuclear power plant,
the vault is below a grade level, and
the vault reduces an angle of attack of the installation site from airborne threats.

19. The system of claim 16, wherein the installation location comprises a berm around the swale at the installation site,
wherein the berm further reduces an angle of attack of the installation site from airborne threats.

20. The system of claim 19, wherein:
the installation location further comprises a vault beneath the transportable nuclear power plant into which a small modular reactor may be lowered from the transportable nuclear power plant,
the vault is below a grade level, and
the vault further reduces an angle of attack of the installation site from airborne threats.
